(19) United States
(12) Patent Application Publication
(10) Pub. No.: US 2025/0340383 A1
(43) Pub. Date: Nov. 6, 2025

(54) TRANSPORT DEVICE FOR TRANSPORTING IN PARTICULAR PHARMACEUTICAL CONTAINERS, AND APPARATUS FOR PROCESSING SUCH CONTAINERS

(71) Applicant: Bausch + Stroebel SE + Co. KG, Ilshofen (DE)

(72) Inventor: Manuel Ruckh, Ilshofen (DE)

(21) Appl. No.: 19/265,421

(22) Filed: Jul. 10, 2025

Related U.S. Application Data
(63) Continuation of application No. PCT/EP2024/050637, filed on Jan. 12, 2024.

(30) Foreign Application Priority Data
Jan. 13, 2023 (DE) 10 2023 100 794.7

(51) Int. Cl. B65G 47/34; B65G 15/28; B65G 21/20

(52) U.S. Cl. CPC B65G 47/34; B65G 15/28; B65G 21/2063; B65G 2201/0235; B65G 2811/0657

(57) ABSTRACT

A transport device for transporting pharmaceutical containers has a transporting path with first and second lateral boundaries, between which containers are conveyable. A blocking element is transferable between a release position and a blocking position. In the release position, the transporting path is released so that containers pass in a transporting direction. In the blocking position, the blocking element is within the transporting path and contactable by containers. An edge element is preferably arranged level with the blocking element relative to the transporting direction. The edge element is transferable relative to the transporting path between a neutral position and an open position. In the neutral position, the edge element forms a section of the second lateral boundary and, in the open position, releases a discharging opening at the second lateral boundary. The containers blocked by the blocking element are dischargeable out of the transporting path via the discharging opening.

### CROSS-REFERENCE TO RELATED APPLICATIONS

This application is a continuation patent application of international application number PCT/EP2024/050637, filed on Jan. 12, 2024, and claims the benefit of German application number 10 2023 100 794.7, filed on Jan. 13, 2023, which are incorporated herein by reference in their entireties and for all purposes.

### FIELD

The present disclosure relates to a transport device for transporting in particular pharmaceutical containers.

Furthermore, the present disclosure relates to an apparatus for processing such containers, which comprises a first station for processing the containers, a second station for processing the containers, and a transport device for transporting the containers from the first station to the second station.

### BACKGROUND

In such an apparatus, for example, containers to be filled are first provided, washed, dried and sterilized, and then filled and sealed. It is known that the containers are conveyed between two consecutive stations by means of a transport device. As part of process control, it may happen that containers have to be discarded, particularly in batches, in order to avoid a hazard caused by a defective batch. The cause of this could be, for example, a faulty process in a station. It is also conceivable, for example, that glass could break in a station, leading to the apparatus being emptied as a precautionary measure. It is known that the containers are discharged via what is known as a discharging device or emptying device. For example, points are provided on the transport device that must be operated manually by a user. The disadvantage here is that a machine guard covering the apparatus must be opened in order to operate the points manually.

Alternatively, a glove port must be provided.

An object underlying the present disclosure is to provide a transport device and an apparatus of the type mentioned at the outset by means of which containers can be discharged more easily.

### SUMMARY

In a first aspect of the present disclosure, a transport device for transporting containers is provided. The containers may be pharmaceutical containers. The transport device defines at least one transporting direction and comprises:
at least one transporting path with a first lateral boundary and a second lateral boundary, between which the containers can be conveyed;
a blocking element which can be transferred relative to the at least one transporting path from a release position to a blocking position and vice versa, wherein in the release position of the blocking element, the at least one transporting path is released in order for the containers to pass in the transporting direction, and wherein in the blocking position, the blocking element is arranged within the at least one transporting path and can be contacted by the containers; and
an edge element which is preferably arranged level with the blocking element in relation to the transporting direction, wherein the edge element can be transferred relative to the transporting path from a neutral position into an open position and vice versa, and wherein, in the neutral position, the edge element forms a section of the second lateral boundary and, in the open position, it releases a discharging opening at the lateral boundary, via which discharging opening the containers blocked by means of the blocking element can be discharged out of the at least one transporting path.

In a second aspect of the present disclosure an apparatus for processing, in particular, pharmaceutical containers is provided. The apparatus comprises a first station for processing the containers, a second station for processing the containers, and a transport device in accordance with the first aspect for transporting the containers from the first station to the second station.

### BRIEF DESCRIPTION OF THE DRAWINGS

The foregoing summary and the following description may be better understood in conjunction with the drawing figures, of which:

FIG. 1: shows a schematic view of the apparatus in accordance with the present disclosure in a preferred embodiment, comprising the transport device in accordance with the present disclosure in a preferred embodiment;

FIG. 2: shows a perspective partial view of the transport device in accordance with the present disclosure;

FIG. 3: shows a (partial) view of the transport device, in the viewing direction of the arrow “3” in FIG. 2;

FIG. 4: shows a perspective view of the transport device, where, in contrast to FIGS. 2, 3 and 5 to 7, a container device of the transport device is also shown;

FIG. 5: shows a perspective partial view of the transport device from FIG. 2, blocking elements assuming a respective release position and edge elements assuming a respective neutral position;

FIG. 6: shows a view corresponding to FIG. 5, the blocking elements being transferred from the release position into a blocking position and the edge elements being transferred from the neutral position into an open position; and

FIG. 7: shows a view corresponding to FIG. 6, the blocking elements assuming a respective blocking position and the edge elements assuming a respective open position.

### DETAILED DESCRIPTION

Although the present disclosure is illustrated and described herein with reference to specific embodiments, the present disclosure is not intended to be limited to the details shown. Rather, various modifications may be made in the details without departing from the present disclosure.

The present disclosure relates to a transport device for transporting, in particular, pharmaceutical containers. The transport device which defines at least one transporting direction and comprises at least one transporting path with a first lateral boundary and a second lateral boundary, between which the containers can be conveyed, and a blocking element which can be transferred relative to the at least one transporting path from a release position to a blocking position and vice versa, wherein, in the release position of the blocking element, the at least one transporting path is released in order for the containers to pass in the transporting direction, and wherein, in the blocking position, the blocking element is arranged within the at least one transporting path and can be contacted by the containers. The transport device further comprises an edge element which is preferably arranged level with the blocking element in relation to the transporting direction, wherein the edge element can be transferred relative to the transporting path from a neutral position into an open position and vice versa, and wherein, in the neutral position, the edge element forms a section of the second lateral boundary and, in the open position, the edge element releases a discharging opening at the lateral boundary, via which discharging opening the containers blocked by means of the blocking element can be discharged out of the at least one transporting path.

In the transport device in accordance with the present disclosure, in particular a movable blocking element and a movable edge element are provided. When the blocking element assumes the release position, the containers can pass the transporting path in the transporting direction, moving between the two lateral boundaries. When the blocking element assumes the blocking position, it is arranged at least in portions within the at least one transporting path. In the blocking position, the blocking element is arranged, for example, within the free cross-section of the transporting path. Containers can contact the blocking element assuming the blocking position. It is also conceivable that a container jam in the transporting path occurs when a container leading in the transporting direction contacts the blocking element and jams subsequent containers. When the edge element on the second lateral boundary assumes the open position, a discharging opening is released. The containers blocked by the blocking element can be discharged from the transporting path through the discharging opening and thus conveniently discharged from the transport device.

In the transport device in accordance with the present disclosure, the blocking element and the edge element can advantageously be moved by means of at least one drive unit. This makes it possible to avoid manual intervention by the user. An existing machine guard can remain closed. This makes the discharge of an entire batch of containers much easier.

The transporting path can preferably be emptied of containers independently of the loading state, for example by “emptying” using at least one drive unit as explained above and a driven transport element of the transport device.

In the present disclosure, the first lateral boundary is preferably arranged fixedly and/or immovably on the transport device and forms a guide for the containers. The blocking element formed separately from the first lateral boundary can be moved in relation to the latter. The transport device thus differs from conventional points, in which the transporting path itself is moved with the first lateral boundary and the second lateral boundary. Instead, the transporting path is opened at the second lateral boundary at the discharging opening.

Preferably, the containers are guided through the discharging opening via the blocking element, so that the blocking element forms a guide element for the containers.

The transport of the containers in the transport device can, for example, be carried out actively.

For example, at least one transport element is provided for the containers, for example a conveyor belt, under the action of which the containers can be transported in the transporting path and can be brought into contact with the blocking element or already accumulated containers. Advantageously, the containers are transported through the discharging opening under the action of at least one transporting path.

Alternatively or additionally, the transport device may be configured to be passive. It is conceivable, for example, that the containers are moved down an inclined plane in the transporting path. A conveyor belt can be omitted in this manner.

The containers are particularly stable containers, for example vials (small bottles).

The blocking element is for example configured to be displaceable transversely and in particular perpendicularly relative to at least one transporting path.

It can be provided that the blocking element is configured to be movable and in particular displaceable in a plane defined by the at least one transporting path. For example, the movement of the blocking element is horizontal.

Position and orientation information, such as “horizontal(ly)”, “vertical(ly”), “above”, “below”, or the like refer in the present case to proper use of the transport device. In this case, the at least one transporting path can advantageously be aligned horizontally.

It may be favorable if the blocking element in the blocking position extends through the at least one transporting path at least as far as into the discharging opening. For example, containers that contact the blocking element can be guided along the blocking element to the discharging opening and preferably through it.

It can advantageously be provided that a through-opening is formed in the first lateral boundary and that the blocking element can be moved through the through-opening into the at least one transporting path, into the blocking position. In this way, the first lateral boundary can form a guide for the containers, which can be stationary. Such a stationary or fixed first lateral boundary has already been discussed. The blocking element can be moved into at least one transporting path through the through-opening, for example below the guide.

In the release position, the blocking element can be arranged, for example, outside the at least one transporting path, in particular completely or partially outside the first lateral boundary.

In an advantageous embodiment of the present disclosure, it is provided that the blocking element comprises or forms a deflection element for the containers, which is aligned at an angle relative to the transporting direction, at least in the blocking position. The angle is advantageously greater than 0° and less than 90°. In the present case, the angle is understood to be the smaller of the two angles between the deflection element and the transporting direction.

The angle may preferably be about 20° to 70°, preferably about 30° to 60°, and more preferably about 40° to 50°. In a preferred embodiment of the present disclosure, the angle is approximately 45°.

The containers moving in the transporting direction can reach the deflection element and, in particular under the action of a conveyor belt, can be guided along the deflection element out of the transporting path and through the discharging opening.

The blocking element, in particular the deflection element, is preferably formed to extend in a straight line.

Alternatively, it can be provided that the blocking element, in particular the deflection element, is curved. For example, a circular arc shape can be provided.

The transport device can preferably comprise at least one conveyor belt on which the containers can be transported, preferably in an upright position, in the at least one transporting path. If there are multiple transporting paths, each transporting path can be assigned its own conveyor belt. Alternatively, it can be provided that a conveyor belt is assigned to two or more transporting paths in order to transport the containers therein.

It is best to transport the containers upright. However, it may also be the case that the containers lie on the transport element, in particular the conveyor belt, so that horizontal transport is also conceivable.

Preferably, as already mentioned, the containers are movable along the deflection element through the discharging opening as the conveyor belt moves.

It can be provided that the blocking element comprises or forms a push-out element with which containers can be pushed out from the at least one transporting path through the through-opening when transferred from the release position into the blocking position.

It proves to be advantageous if the containers, when the blocking element assumes the blocking position, pass via the discharging opening to a lateral edge of the transport device and preferably fall over the edge of the transport device.

This offers, for example, a structurally simple possibility to eject a large number of containers from the transport device.

The transport device advantageously comprises a container device for receiving containers discharged from the transporting path. For example, the containers fall from the transport device into the container device.

The container device comprises, for example, a collecting container and a shaft arranged above it through which the containers fall into the collecting container.

The container device can, for example, have a sensor element for determining the fill level of containers. If the fill level is too high, for example, a message can be sent to a user.

Alternatively or additionally, for example, a transport element of the transport device can be stopped.

It is expedient in particular if the transport device comprises at least one drive unit, in particular a controllable drive unit. For example, a drive unit is provided for the blocking element to move it from the release position into the blocking position and/or vice versa.

Alternatively or additionally, for example, a drive unit is provided for the edge element for transferring it from the neutral position into the open position and/or vice versa.

The at least one drive unit can be configured in different ways. For example, a pneumatic drive unit is provided. Alternatively, an electrical, mechanical or magnetic drive unit is conceivable. A hydraulic drive unit is also conceivable.

The at least one drive unit may comprise a drive element, for example a piston-cylinder unit. The drive element can be arranged below the at least one transporting path in the direction of gravity, it being coupled to the blocking element and/or to the edge element via at least one coupling element extending in the height direction. The drive element can be coupled directly or indirectly to the blocking element and/or to the edge element. The coupling elements are arranged, for example, on opposite sides of the transport device and extend from below the transporting path upwards. The arrangement of the drive element below the transporting path facilitates access to the transport device from above. Any housing for the drive element can preferably be provided on the underside in a space-saving manner.

It is expedient if the common drive unit is provided for the blocking element and the edge element, the transport device comprising respective coupling elements for coupling with the blocking element and with the edge element. The common drive unit simplifies the structural design of the transport device. The activation of the drive unit, in particular the drive element, leads to the movement of both the blocking element and the edge element. This enables the transport device to function reliably.

In the case of a common drive unit, the drive element moves, for example, a displacement body, which can be configured as a carriage. The displacement body is connected directly or indirectly to the blocking element or the edge element via the coupling elements mentioned above.

The transport device may preferably comprise a control unit. The control unit is coupled, for example, to a drive unit of the transport device, for example for at least one transport element, for example the at least one conveyor belt, as well as to the at least one drive unit for the blocking element and/or for the edge element. By controlling the control unit, for example, the transport element can be activated and the blocking element can be moved into the blocking position and the edge element into the open position. This makes it possible, for example, to “empty” the transport device of containers.

It can be provided that the transport device comprises a control unit coupled to the at least one drive unit and a sensor unit coupled to the control unit, the at least one drive unit being activatable depending on a signal from the sensor unit for transferring the blocking element from the release position into the blocking position and/or the edge element from the neutral position into the open position. The sensor unit can, for example, detect a malfunction of a station in the container processing apparatus. Based on this, the drive unit can be activated to eject the containers from the transport device. Preferably, a drive unit of the at least one transport element is also activated in this case.

The transport device can comprise more than one transporting path.

For example, the transport device comprises a further transporting path which is arranged laterally next to the transporting path and in particular aligned parallel to it, the further transporting path being delimited by the second lateral boundary and a third lateral boundary, between which the containers can be conveyed.

It is desirable that containers that are transported in the further transporting path can also be discharged.

For this purpose, it is preferably provided, for example, that the transport device comprises a further edge element, which is preferably arranged level with the blocking element in relation to the transporting direction and which can be transferred from a neutral position into an open position and vice versa, wherein, in the neutral position, the further edge element forms a section of the third lateral boundary and, in the open position, it releases a discharging opening at the third lateral boundary, wherein the edge elements in their respective open positions release the two discharging openings and the containers can be discharged out of both transporting paths through the discharging openings.

By releasing the additional discharging opening, the containers can be discharged from the additional transporting path. Furthermore, the containers can preferably pass from the first transporting path into the second transporting path and also be discharged via the additional discharging opening.

In the blocking position, the blocking element preferably projects through the further transporting path, at least into the further discharging opening, preferably up to an edge of the transport device.

It is advantageous if the further edge element is coupled to the edge element, in particular mechanically via at least one connecting element, and can be transferred together with the latter, in particular by means of a common drive unit, from the neutral position into the open position and/or vice versa. This eliminates the need for a separate drive unit for the further edge element and simplifies the structural design of the transport device. For example, a common drive unit is provided for the blocking element and the edge elements. The above-mentioned coupling element is, for example, coupled to the further edge element, which in turn is coupled to the first-mentioned edge element via the connecting element.

The at least one connecting element is, for example, a bridge under which the containers can be moved through, in the transporting paths, when the blocking element assumes the release position and the edge elements assume the neutral positions.

The further edge element can, for example, have a greater extension in relation to the transporting direction than the edge element.

As mentioned at the outset, the containers can be moved in the transporting direction in the at least one transporting path.

The transport device can define a further transporting direction which is oriented opposite to the transporting direction. In particular, in this case, at least one transport element, in particular a conveyor belt, of the transport device is provided, depending on the operating state of which the containers in the at least one transporting path can be conveyed selectively in the transporting direction or in the further transporting direction. Depending on the operating state, the containers in the apparatus are conveyed, for example, from the first station towards the second station or from the second station towards the first station. It may be particularly advantageous and desirable if the transport device can also be freed of containers which are arranged downstream of the blocking element with respect to the transporting direction, if the discharge of the containers in the above explanations referred to containers which are arranged upstream in relation to the blocking element.

It can therefore be expedient if the transport device comprises a further blocking element which can be transferred from a release position into a blocking position and vice versa relative to the at least one transporting path, the at least one transporting path being released in the release position of the further blocking element for the containers to pass in the further transporting direction and wherein, in the blocking position, the further blocking element is arranged within the at least one transporting path and can be contacted by the containers in order to discharge the containers from the at least one transporting path via the discharging opening. This makes it possible, in particular, to “empty” the transport device in the further transporting direction. For example, the at least one conveyor belt for transporting the containers is moved in the further transporting direction and the further blocking element is transferred into the blocking position. It is understood that in this case the edge element assumes the open position, such that the discharging opening is released.

The blocking element is preferably configured to correspond to the further blocking element. In the present case, this can be understood in particular to mean that the further blocking element is a deflection element or a push-out element. The further blocking element can protrude through the transporting path into the discharging opening. For example, the further blocking element is moved into the transporting path through the through-opening of the first lateral boundary. For the rest, reference is made to the above comments with regard to the blocking element.

It can be provided that the blocking element and the further blocking element are configured symmetrically relative to one another or substantially symmetrically with respect to a plane of symmetry perpendicular to the transporting direction.

It can be provided that the transport device comprises a blocking body which comprises or forms the blocking element and the further blocking element.

In a plan view, the blocking body is, for example, wedge-shaped or triangular, with a vertex pointing in the direction of the at least one transporting path. The blocking elements can be formed by both legs of the wedge or triangle.

As explained above, the present disclosure further relates to an apparatus for processing in particular pharmaceutical containers. The apparatus comprises a first station for processing the containers, a second station for processing the containers and a transport device of the type described above for transporting the containers from the first station to the second station.

The advantages already mentioned in connection with the transport device in accordance with the present disclosure can also be achieved with the apparatus. In this respect, reference is made to the above statements.

Advantageous embodiments of the apparatus in accordance with the present disclosure result from advantageous embodiments of the transport device in accordance with the present disclosure. In this respect, reference is made to the above statements.

The first station can, for example, be a washing station where the containers are washed. The second station may, for example, be a drying station and in particular comprise what is known as a tunnel dryer for drying and sterilizing the containers.

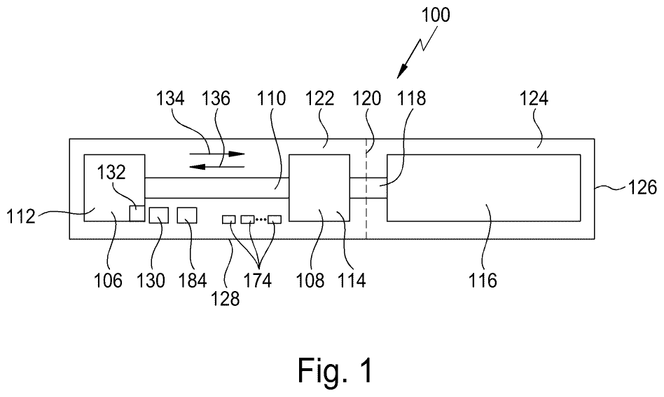

FIG. 1 is a schematic view of a preferred embodiment of an apparatus in accordance with the present disclosure for processing pharmaceutical containers 102, which overall is denoted by reference sign 100. In the present embodiment, the containers 102 are small bottles (vials) 104. However, the apparatus 100 could also be configured to process other types of containers 102.

In the present example, the apparatus 100 comprises a first station 106 and a second station 108, which are connected to one another via a transport device 110. The transport device 110 is a preferred embodiment of the transport device in accordance with the present disclosure, which will be discussed in detail below with reference to the other figures.

For example, the first station 106 may be a washing station 112 and the second station 108 a drying station 114. The drying station 114 may in particular comprise a tunnel dryer for drying and sterilizing the containers 102.

The apparatus 100 further comprises a filling machine 116 for the containers 102, which is connected to the second station 108 via a further transport device 118. The filling machine 116 may, for example, comprise a filling station and at least one dosing station for respectively filling and closing the containers 102.

In FIG. 1, the dashed line 120 indicates a zone separation between a first zone 122 and a second zone 124, which differ from each other in terms of their purity class. In this case, the purity class of the second zone 124 is higher than that of the first zone 122. For example, the second zone 124 is covered by an isolator device 126, whereas for the first zone 122 a machine guard 128 in the form of a cover is sufficient.

The apparatus 100 further comprises a control unit 130, which is in particular also a control unit of the transport device 110. The operation of the apparatus 100 and in particular also of the transport device 110 can be controlled and/or regulated by the control unit 130.

In the present case, the apparatus 100 comprises at least one sensor unit 132, which in particular can also be a component of the transport device 110. A sensor unit 132 at the first station 106 is shown by way of example. It can be provided that in the event of a disruption of the processing at the station 106, a signal is provided by the sensor unit 132 to the control unit 130. Alternatively or additionally, a sensor unit can be arranged, for example, at the station 108.

The arrows 134 and 136 indicate transporting directions in which the containers 102 can be conveyed by means of the transport device 110. In this case, the transporting direction 134 corresponds to the direction through which the containers 102 travel during normal processing. The transporting direction 136 is opposite to the transporting direction 134 and is the “further transporting direction” in the sense of the present patent application.

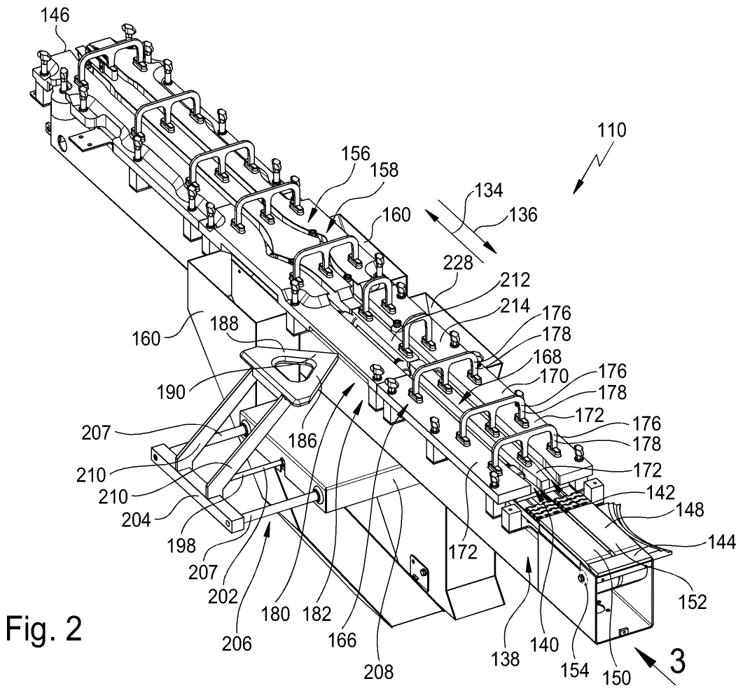

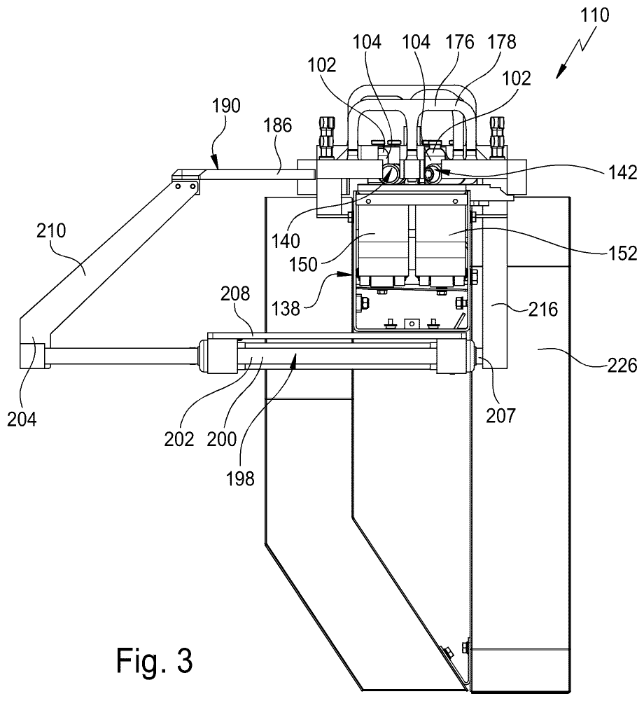

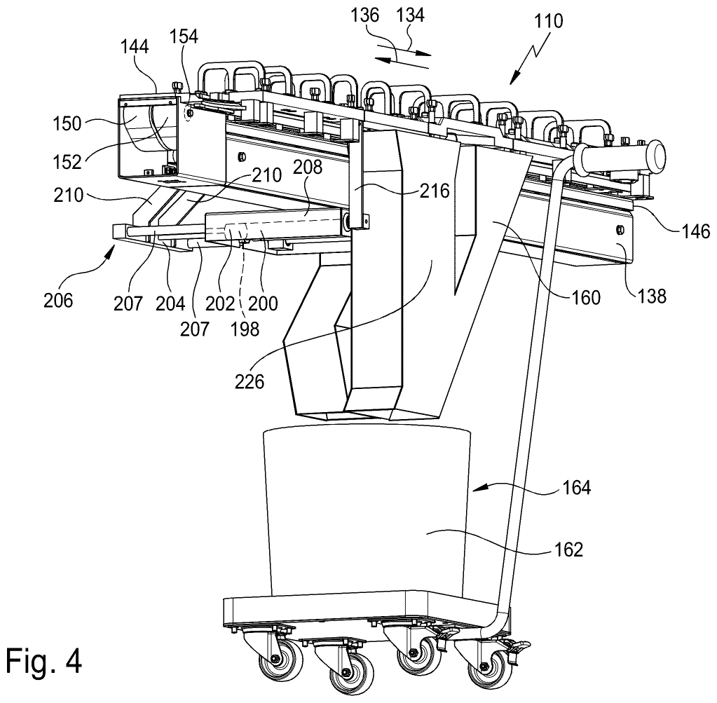

As can be seen in particular from FIG. 2 to 4, the transport device 110 comprises a support device 138 which, in the present example, is essentially cuboid-shaped or profile-like. The support device 138 can, for example, be held on a frame or substructure (not shown) of the apparatus 100 or can itself stand on a set-down surface. The support device 138, like the transport device 110, is formed as a whole to extend longitudinally along the transporting direction 134.

In the present example, the transport device 110 comprises at least one transporting path 140 for the containers 102. In the present case, two transporting paths 140, 142 are provided. The transporting paths 140, 142 run in particular parallel to one another over the majority of the transport device 110. In this present case, the transporting path 142 is the “further transporting path” within the meaning of this patent application.

The transport device 110 has a coupling side 144 at which the containers 102 are taken over from the first station 106. Furthermore, a decoupling side 146 is provided, via which the containers 102 are transferred directly or indirectly (for example via a further transport device not shown in the drawing) to the second station 108. The transporting paths 140, 142 extend over the largest region from the coupling side 144 to the decoupling side 146, with the exception of an initial region 148 on the coupling side 144.

In the present case, each transporting path 140, 142 is assigned its own conveyor element for moving the containers 102. The conveyor elements are conveyor belts 150 and 152 respectively. Alternatively, a common conveyor belt 150, 152 could be provided. The conveyor belts 150, 152 are belt conveyors which are driven by a respective drive unit 154. The actuation is carried out by the control unit 130.

In this case, the conveyor belts 150, 152 can each assume two operating states. In a first state, which is a normal operating state, the containers 102 are moved in the transporting direction 134. In a second operating state, the containers 102 are moved in the opposite transporting direction 136.

In the present case, the containers 102 can be moved as stable vials 104 standing on the conveyor belts 150, 152. A bottle neck guide can optionally be provided.

However, it may also be the case that the containers 102 arrive in a lying state on the conveyor belts 150, 152. In such a case, the containers 102 can be discharged via a discharging device 156 included in the transport device 110. The discharging device 156 is configured in the present case as a horizontal discharging means 158 that is known per se. Discharged containers 102 pass through at least one shaft 160 into a collecting container 162 of a container device 164 of the apparatus 100. The container device 164 may be part of the transport device 110.

The transporting paths 140, 142 have lateral boundaries, between which the containers 102 are conveyed in each case. In this case, the transporting paths 140, 142 share a lateral boundary.

The transporting path 140 has a first lateral boundary 166 and a second lateral boundary 168 spaced therefrom. In relation to the transporting direction 134, in the present example the boundary 166 is arranged on the left-hand side of the transporting path 140 and the boundary 168 is arranged on the right-hand side of the transporting path 140.

The transporting path 142 has the (second) lateral boundary 168 on the left-hand side in relation to the transporting direction 134 and, spaced therefrom and on the right-hand side with respect to the transporting direction 134, a third lateral boundary 170.

In the direction of travel of the transport device 110, the boundaries 166, 168 and 170 are each divided into individual segments 172. The segments 172 are preferably format parts that can be part of format sets 174 of the transport device 110. In this case, the respective components of the format sets 174 differ in at least one container-specific property. The format parts can preferably, as in the present example, be exchanged manually and without tools, which facilitates conversion of the transport device 110 to other container formats.

Respective adjacent segments 172 of the boundaries 166, 168 and 170 may be connected to one another. For this purpose, for example, at least one connecting element 176 is provided which connects two or three segments 172 of the respective boundaries 166, 168 and 170 with one another. The connecting element 176 can be configured as a bridge 178, under which the containers 102 can be conveyed through the transporting paths 140, 142 during operation of the transport device 110.

With the transport device 110, containers 102 can be purposely removed from the processing process. For this reason, the transport device 110 can also be regarded as a discharging device 180 or as an emptying device 182, or the transport device 110 forms such devices 180, 182.

Ejecting the containers 102 is necessary, for example, if a faulty process is carried out during processing, for example in the first station 106. This can be detected, for example, with the sensor unit 132, which transmits a corresponding signal to the control unit 130, from which the ejection process is started. Alternatively or additionally, the ejection process can be triggered by a user. For this purpose, for example, an operating unit 184 is provided.

However, in contrast to the emptying devices known from the prior art with manually operated points, the present disclosure does not require the user to manually intervene in the transport device 110 or even to open the machine guard 128.

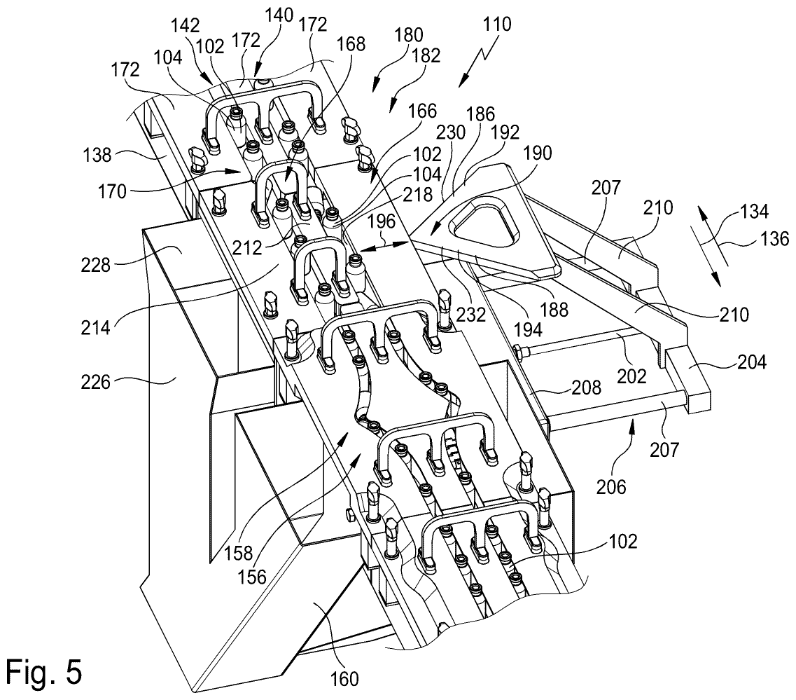

As is clear in particular from FIG. 5 to 7, the transport device 110 comprises a blocking element 186. In the present case, in the preferred embodiment of the present disclosure, a further blocking element 188 is provided, the “further blocking element” in the sense of the present patent application.

In the present example, both blocking elements 186, 188 are part of a blocking body 190, but they could also be formed separately from each other. The blocking elements 186, 188 are in the present case deflection elements 192, 194, via which the containers 102 conveyed in the transporting paths 140, 142 can be deflected.

In the present case, the blocking elements 186, 188 are formed symmetrically relative to one another with respect to a plane of symmetry which is oriented perpendicularly to the transporting direction 134.

In a plan view of the transport device 110, the blocking body is configured wedge-shaped or triangular, with a vertex pointing in the direction of the transporting paths 140, 142. The blocking elements 186, 188 are formed by the legs of the wedge or triangle.

The blocking body 190, and thus the blocking elements 186, 188, is/are configured to be movable relative to the transporting path 140. In particular, the blocking body 190 is configured to be displaceable. The displacement of the blocking body 190 takes place essentially in a plane defined by the transporting paths 140, 142. The displacement direction is transverse and in particular perpendicular to the transporting direction 136 (double arrow 196).

To move the blocking body 190, the transport device 110 comprises a drive unit 198 coupled to the control unit 130. The drive unit 198 comprises a drive element 200, here configured as a piston-cylinder unit 202.

In the present case, the piston-cylinder unit 202 is arranged below the support device 138 and the transporting paths 140, 142 and is held on the support device 138. The piston-cylinder unit 202 is connected to a coupling part 204, which in the present case is configured as a displacement body 206 or carriage with two sliding elements 207. The displacement body 206 is displaceably mounted on a holding part 208 and can be displaced transversely and in particular perpendicularly to the transporting direction 134. On one side, to the left in relation to the transporting direction 134, the displacement body 206 is coupled to the blocking body 190 via at least one (in this case two) coupling element 210 which extends in a height direction.

Relative to the transporting direction 134 level with the blocking element 186, in particular the blocking body 190, the transport device 110 comprises an edge element 212. In a neutral position, the edge element 212 partially forms the second lateral boundary 168 for limiting both transporting paths 140, 142. In this case, the edge element 212 forms one of the segments 172.

Furthermore, the transport device 110 comprises a further edge element 214, the “further edge element” within the meaning of the present patent application. In a neutral position, the edge element 214 forms the third lateral boundary 170 in portions and in turn also forms a segment 172.

The edge elements 212, 214 are mechanically coupled to one another, said elements being connected to one another in particular via at least one (in this case two) bridge 178.

In relation to the transporting direction 134, the edge element 214 has a greater extension than the edge element 212 and projects beyond it on both sides.

In the present case, the edge elements 212, 214 are also coupled to the drive unit 198 and can be moved by it. The edge elements 212, 214 are coupled to the displacement body 206 via at least one coupling element 216. In the present case, two coupling elements 216 are provided, which are connected to the edge element 214 and are each connected to one of the sliding elements 207 of the displacement body 206.

Accordingly, only one common drive unit 198 is provided for moving the blocking body 190 on the one hand and the edge elements 212, 214 on the other hand. Separate drive units are not required, which simplifies the structural design of the transport device 110.

The coupling elements 210, 216 are arranged on opposite sides of the transport device 110. The displacement of the blocking body 190 and the edge elements 212, 214 occurs together and in the same displacement direction. However, in this case, either the blocking body 190 is displaced into the transporting paths 140, 142 and the edge elements 212, 214 are displaced away from the transporting paths 140, 142, or vice versa.

During normal operation of the transport device 110, the blocking body 190 assumes a release position, which can be seen in FIGS. 2, 3 and 5. In the release position, the blocking body 190 is released outside both transporting paths 140, 142 such that the containers 102 can pass freely therein in the transporting direction 134. In particular, the respective cross-section of the transporting path 140, 142 is free.

During normal operation, the edge elements 212, 214 are positioned such that they form a section of the lateral boundaries 168 and 170.

In normal operation, the piston-cylinder unit 202 is extended, but the kinematics could also be reversed.

The drive unit 198 can be activated to empty the transport device 110 and to discharge the containers 102. This can be triggered by actuation by the control unit 130 as a result of the signal from the sensor unit 132 or by the user on the operating unit 184.

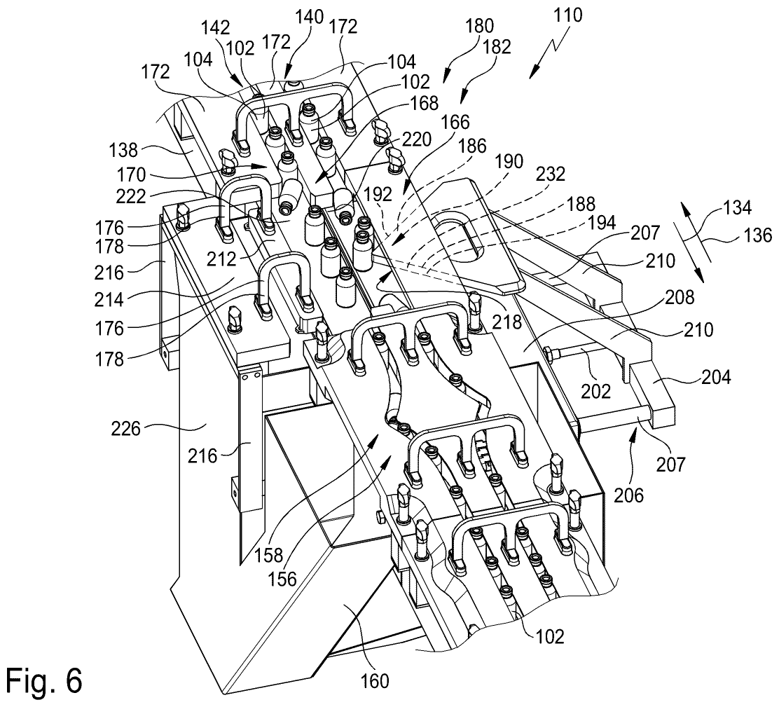

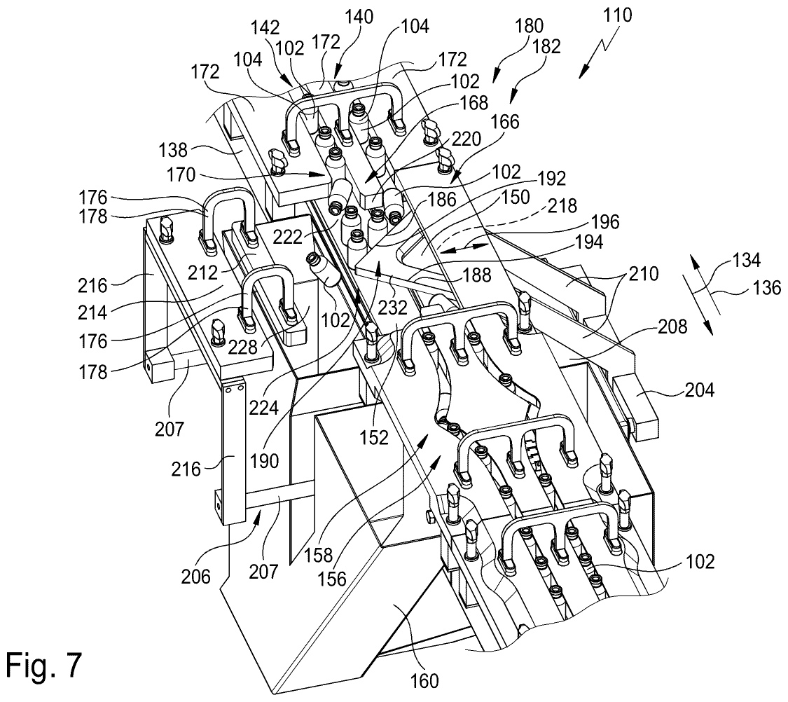

The piston-cylinder unit is activated and retracted. This results in the blocking body 190 and the edge elements 212, 214 being displaced transversely and in particular perpendicularly to the transporting paths 140, 142 (FIGS. 6 and 7).

The blocking body 190 can be moved through a through-opening 218 in the first lateral boundary 166, into the transporting paths 140, 142. The guide, formed by the boundary 166, above the through-opening 218 can thus remain stationary, so that the corresponding segment 172 itself does not have to be moved.

In particular, the first lateral boundary 166 is arranged fixedly on the transporting path 140, whereas the blocking body 190 is formed separately from the boundary 166 and is movable between the release position and the blocking position.

The edge element 212 is displaced out of the boundary 168 and releases a discharging opening 220 in the boundary 168. The edge element 212 can also be moved through the transporting path 142.

The edge element 214 is displaced out of the boundary 170 and releases a discharging opening 222 in the boundary 170.

In this case, the edge elements 212, 214 are displaced to such an extent that the edge element 212 is also displaced through the discharging opening 222 and an edge 224 of the transport device 110 is released.

Below the edge 224, a shaft 226 of the container device 164 is arranged, the upper opening 228 of which is also released.

The blocking body 190 can be displaced so far that it projects beyond the transporting path 140 and the discharging opening 220 into the transporting path 142, in this case up to the edge 224. The blocking body 190 thereby also engages in the discharging opening 222.

After displacement, the blocking body 190 assumes a blocking position in which it is arranged within the transporting paths 140, 142 and can be contacted by the containers 102. The edge elements 212, 214 assume respective open positions in which the discharging openings 220, 222 are released.

When the conveyor belts 150, 152 are activated, the containers 102 moving in the transporting direction 134 reach the deflection element 192. The deflection element 192 is aligned at an angle relative to the transporting direction 134, which in this case is approximately 45°. When the conveyor belt 150, 152 is moving, the containers 102 contact the deflection element 192 and are guided along it as far as the edge 224. In this case, containers 102 from the transporting path 140 are first guided via the discharging opening 220 to the transporting path 142 and then via the discharging opening 222 to the edge 224.

At the edge 224, the containers 102 tip over and fall through the shaft 226 into the collecting container 162.

One of the shafts 160 and the shaft 226 open into each other, so that only one collecting container 162 is required, which in this case is configured in the shape of a bucket.

Containers 102 which, when the drive unit 198 is activated, are located level with the blocking element 186 in relation to the transporting direction 134, can be pushed out by the latter, so that the blocking element 186 also forms a push-out element 230.

Starting from the blocking position, the blocking body 190 can be transferred into the release position. In a corresponding manner, the edge elements 212, 214 can be returned to the neutral position. The joint displacement movement is carried out by means of the drive unit 198.

In the transport device 110, the containers 102 can also be discharged if they are arranged downstream of the blocking body 190 in relation to the transporting direction 134. For this purpose, the operating state of the conveyor belts 150, 152 can be changed so that the containers 102 are moved in the (further) transporting direction 136.

This offers the advantage, for example, that the apparatus does not have to be freed of containers via the isolator device 126 if, for example, a fault occurs at or before the station 108. Emptying can be done via the transport device 110.

While in the case described so far the blocking element 186 is effective, in this operating state the blocking element 188 is effective, which can also act as a deflection element 194 and as a push-out element 232.

The above statements apply correspondingly. The containers 102 are also moved through the discharging openings 220, 222 to the edge 224 and fall into the collecting container 162.

The present disclosure was described above using the example of the transport device 110 with two transporting paths 140, 142. It is to be understood that the present disclosure is not limited thereto. The transport device in accordance with the present disclosure can also have only one transporting path. In this case, only one edge element is required, which creates a discharging opening through which the containers can be discharged from the one transporting path.

Preferably, even with only one transporting path, it is possible, as described above, to reverse the transporting direction so that containers 102 arranged both upstream and downstream of the blocking body can be discharged.

It is understood that the present disclosure is not limited to the possibility that the transporting direction can be reversed. In the transport device in accordance with the present disclosure, it is sufficient that only containers 102 that are moved in one transporting direction can be discharged. Accordingly, only one blocking element is required in the transport device 110 in accordance with the present disclosure.

### LIST OF REFERENCE SIGNS

100 apparatus
102 container
104 vial
106 first station
108 second station
110 transport device
112 washing station
114 drying station
116 filling machine
118 transport device
120 dashed line
122 first zone
124 second side
126 insulator apparatus
128 machine guard
130 control unit
132 sensor unit
134 transporting direction
136 further transporting direction
138 support device
140 transporting path
142 transporting path
144 coupling side
146 decoupling side
148 initial region
150 conveyor belt
152 conveyor belt
154 drive unit
156 discharging device
158 horizontal discharging means
160 shaft
162 collecting container
164 container device
166 first lateral boundary
168 second lateral boundary
170 third lateral boundary
172 segment
174 format set
176 connecting element
178 bridge
180 discharging device
182 emptying device
184 operating unit
186 blocking element
188 blocking element
190 blockade body
192 deflection element
194 deflection element
196 double arrow
198 drive unit
200 drive element
202 piston-cylinder unit
204 coupling part
206 displacement body
207 sliding element
208 holding part
210 coupling element
212 edge element
214 edge element
216 coupling element
218 through-opening
220 dispensing opening
222 dispensing opening
224 edge
226 shaft
228 opening
230 push-out element
232 push-out element

1. A transport device for transporting pharmaceutical containers and defining at least one transporting direction, comprising at least one transporting path with a first lateral boundary and a second lateral boundary, between which the pharmaceutical containers are conveyable,
a blocking element, which is transferable relative to the at least one transporting path from a release position into a blocking position, and vice versa,
wherein, in the release position of the blocking element, the at least one transporting path is released in order for the pharmaceutical containers to pass in the at least one transporting direction, and wherein, in the blocking position, the blocking element is arranged within the at least one transporting path and is contactable by the pharmaceutical containers,
an edge element, wherein the edge element is transferable relative to the at least one transporting path from a neutral position into an open position, and vice versa; wherein in the neutral position, the edge element forms a section of the second lateral boundary and, in the open position, the edge element releases a discharging opening at the second lateral boundary, via which discharging opening the pharmaceutical containers blocked by means of the blocking element are dischargeable out of the at least one transporting path.

2. The transport device according to claim 1,
wherein
at least one of the following applies:
the blocking element is configured to be displaceable transversely or perpendicularly relative to the at least one transporting path;
the blocking element is configured to be movable in a plane defined by the at least one transporting path.

3. The transport device according to claim 1,
wherein
the blocking element projects in the blocking position through the at least one transporting path at least as far as the discharging opening.

4. The transport device according to claim 1,
wherein
a through-opening is formed in the first lateral boundary and wherein the blocking element is movable through the through-opening into the at least one transporting path into the blocking position.

5. The transport device according to claim 4,
wherein
the blocking element comprises or forms a push-out element with which containers are pushed out from the at least one transporting path through the through-opening upon transfer from the release position to the blocking position.

6. The transport device according to claim 1,
wherein
the blocking element is arranged outside the at least one transporting path in the release position, completely or in part outside the first lateral boundary.

7. The transport device according to claim 1,
wherein
the blocking element comprises or forms a deflection element for the pharmaceutical containers which is oriented at an angle relative to the at least one transporting direction.

8. The transport device according to claim 7,
wherein
the angle is preferably approximately 20° to 70°.

9. The transport device according to claim 7,
wherein
the deflection element, extends in a straight line or is curved.

10. The transport device according to claim 7,
wherein
the transport device comprises at least one conveyor belt on which the pharmaceutical containers are conveyable, in the at least one transporting path, wherein the pharmaceutical containers are movable along the deflection element through the discharging opening by movement of the at least one conveyor belt.

11. The transport device according to claim 1,
wherein
the pharmaceutical containers pass through the discharging opening to a lateral edge of the transport device when the blocking element assumes the blocking position, and fall over the lateral edge of the transport device.

12. The transport device according to claim 1,
wherein
the transport device comprises a container device for receiving containers discharged from the at least one transporting path.

13. The transport device according to claim 12,
wherein
at least one of the following applies:
the container device has a collecting container and a shaft arranged above it, through which the pharmaceutical containers fall into the collecting container;
the container device has a sensor element for determining a fill level of containers.

14. The transport device according to claim 1,
wherein
the transport device comprises at least one actuatable drive unit, at least one of the following applying:
a drive unit is provided for the blocking element for transferring from the release position to the blocking position and/or vice versa;
a drive unit is provided for the edge element for transferring from the neutral position into the open position and/or vice versa.

15. The transport device according to claim 14,
wherein
the at least one actuatable drive unit comprises a drive member which is arranged below the at least one transporting path in a direction of gravity and which is coupled to the blocking element and/or to the edge element via at least a coupling element extending in a height direction.

16. The transport device according to claim 14,
wherein
a common drive unit is provided for the blocking element and the edge element, the transport device comprising respective coupling elements for coupling to the blocking element and to the edge element.

17. The transport device according to claim 14,
wherein
the transport device comprises a control unit coupled to the at least one actuatable drive unit and a sensor unit coupled to the control unit, the at least one actuatable drive unit being activatable depending on a signal from the sensor unit for transferring the blocking element from the release position to the blocking position and/or the edge element from the neutral position to the open position.

18. The transport device according to claim 1,
wherein
the transport device comprises a further transporting path which is arranged laterally next to the at least one transporting path and the further transporting path is delimited by the second lateral boundary and a third lateral boundary, between which the pharmaceutical containers are conveyable.

19. The transport device according to claim 18,
wherein
the transport device comprises a further edge element which is transferable from a neutral position into an open position and vice versa, wherein, in the neutral position, the further edge element forms a section of the third lateral boundary, and, in the open position, the further edge element releases a discharging opening at the third lateral boundary, wherein the further edge elements in their respective open positions release the two discharging openings and the pharmaceutical containers are dischargable from both transporting paths through the discharging openings.

20. The transport device according to claim 19,
wherein
the blocking element in the blocking position projects through the further transporting path at least as far as into the further discharging opening.

21. The transport device according to claim 19,
wherein
the further edge element is coupled to the edge element, via at least one connecting element, and is transferable together therewith, by means of a common drive unit, from the neutral position into the open position and/or vice versa.

22. The transport device according to claim 21,
wherein
the at least one connecting element is a bridge under which the pharmaceutical containers are movable in the at least one transporting path when the blocking element assumes the release position and the edge elements assume the neutral positions.

23. The transport device according to claim 19,
wherein
the further edge element has a greater extension in relation to the at least one transporting direction than the edge element.

24. The transport device according to claim 1,
wherein
the transport device defines a further transporting direction which is oriented opposite to the at least one transporting direction, wherein at least one transport element, of the transport device is provided, depending on an operating state of which the pharmaceutical containers in the at least one transporting path are conveyable selectively in the at least one transporting direction or in the further transporting direction.

25. The transport device according to claim 24,
wherein
the transport device comprises a further blocking element which is transferable from a release position to a blocking position and vice versa, in relation to the at least one transporting path,
wherein the at least one transporting path is released, in the release position of the further blocking element, for the pharmaceutical containers to pass in the further transporting direction, and wherein, in the blocking position, the further blocking element is arranged within the at least one transporting path and is contactable by the pharmaceutical containers in order to discharge the pharmaceutical containers from the at least one transporting path via the discharging opening.

26. The transport device according to claim 25,
wherein
the blocking element is configured to correspond to the further blocking element, in particular that the blocking element and the further blocking element are configured symmetrically relative to one another or substantially symmetrically with respect to a plane of symmetry perpendicular to the at least one transporting direction.

27. The transport device according to claim 25,
wherein
at least one of the following applies:
the transport device comprises a blocking body which comprises or forms the blocking element and the further blocking element;
the blocking body has a wedge-shaped or triangular shape in a plan view, with an apex pointing in a direction of the at least one transporting path.

28. The transport device according to claim 1,
wherein
the edge element is arranged level with the blocking element in relation to the at least one transporting direction.

29. An apparatus for processing pharmaceutical containers, comprising a first station for processing the pharmaceutical containers, a second station for processing the pharmaceutical containers, and a transport device for transporting pharmaceutical containers defining at least one transporting direction,
the transport device comprising at least one transporting path with a first lateral boundary and a second lateral boundary, between which the pharmaceutical containers are conveyable,
a blocking element, which is transferable relative to the at least one transporting path from a release position into a blocking position, and vice versa,
wherein, in the release position of the blocking element, the at least one transporting path is released in order for the pharmaceutical containers to pass in the at least one transporting direction, and wherein, in the blocking position, the blocking element is arranged within the at least one transporting path and is contactable by the pharmaceutical containers,
an edge element, wherein the edge element is transferable relative to the at least one transporting path from a neutral position into an open position, and vice versa; wherein in the neutral position, the edge element forms a section of the second lateral boundary and, in the open position, the edge element releases a discharging opening at the second lateral boundary, via which discharging opening the pharmaceutical containers blocked by means of the blocking element are dischargeable out of the at least one transporting path.

30. The apparatus according to claim 29,
wherein
the first station is a washing station and the second station is a drying station.
